(19) United States
(12) Patent Application Publication
(10) Pub. No.: US 2019/0291378 A1
(43) Pub. Date: Sep. 26, 2019

(54) METHOD FOR PRODUCING CONTAINER WITH MEANS FOR IMPROVED CLOSURE

(71) Applicants: ZEON CORPORATION, Chiyoda-ku, Tokyo (JP); YUPO CORPORATION, Chiyoda-ku, Tokyo (JP)

(72) Inventor: Onesio Luis THESING, Ecublens (CH)

(73) Assignees: ZEON CORPORATION, Chiyoda-ku, Tokyo (JP); YUPO CORPORATION, Chiyoda-ku, Tokyo (JP)

(21) Appl. No.: 16/304,363

(22) PCT Filed: May 31, 2017
(86) PCT No.: PCT/EP2017/063225

§ 371 Date: Nov. 26, 2018

(30) Foreign Application Priority Data
May 31, 2016 (EP) 16172330.9

(51) Int. Cl. B31B 50/81; B31B 50/26; B31B 50/62; B31B 50/20; B65D 85/10

(52) U.S. Cl. CPC B31B 50/814; B31B 50/26; B31B 2110/35; B31B 50/20; B65D 85/1045; B31B 50/62

(57) ABSTRACT

A method for producing a laminar blank having a microsuction element, the method comprising: conveying a laminar blank along a first path, the laminar blank having an inner surface and an outer surface; conveying a microsuction tape along a second path, which is different to the first path; contacting a first portion of the microsuction tape with the outer surface of a first portion of the laminar blank, to secure the first portion of the microsuction tape to the first portion of the laminar blank; and cutting the microsuction tape to separate the first portion of the microsuction tape from the remainder of the microsuction tape, to thereby provide a laminar blank having a microsuction element.

The present invention relates to a method for the production of containers for consumer goods having a housing and a lid movable relative to the housing. Methods according to the present invention find particular application in the production of containers for smoking articles, such as cigarettes.

It is known to package elongate smoking articles and other consumer goods in containers formed from folded laminar blanks. Elongate smoking articles, such as cigarettes and cigars, are commonly sold in hinge-lid packs having a box for housing the smoking articles and a lid connected to the box about a hinge line extending across the back wall of the container. The hinge-lid pack may also comprise an inner frame secured to an inner surface of the box, the inner frame having front and side walls against which the lid closes. Such packs are typically constructed from laminar cardboard blanks. In use, the lid is pivoted about the hinge line to open the pack and so gain access to the smoking articles held in the box.

In many cases, it is important to ensure that the lid remains in the closed position during normal handling, so that, for example, the consumer goods do not accidentally get exposed or fall out of the container. For smoking articles it can be particularly important that the lid remains tightly shut in the closed position, so that the freshness of the articles can be preserved.

Various mechanisms have been proposed for improving the interaction between the lid and the box of such containers, and in particular, for reducing the chances of the lid inadvertently moving away from the closed position during normal handling. For example, retention cuts may be provided on the inner frame for interacting with the lid. Alternatively, a temporary adhesive may be provided on the lid or the box. However, such mechanisms deteriorate and become less effective after several repetitions of opening and closing of the lid. This can be particular problematic for containers containing smoking articles, where a consumer may need to open and close the lid on multiple occasions each time they access an individual smoking article.

Furthermore, where an adhesive is provided on the lid or box loose material from the consumer goods—such as loose tobacco material from a smoking article—can become undesirably stuck to the adhesive during use of the container. This can result in an undesirable appearance of the container and a less effectively functioning closing mechanism. This can also create a gap that can allow air to pass into the container when the lid is in a closed position, which can result in an undesired change in the moisture level of the consumer goods.

In addition, the incorporation of an adhesive between the lid and the box may cause problems during high speed manufacture of containers. It will typically be most convenient to incorporate any adhesive regions onto the laminar blanks for forming the container, prior to the steps of assembly of the container. However, it is important to prevent the adhesive from undesirably adhering the laminar blanks to each other or to the apparatus during processing and assembly steps.

It would be desirable to provide a novel method for the production of containers having improved closure means, without significant modification of existing container design or packaging equipment and techniques.

According to the present invention, there is provided a method for producing a laminar blank having a microsuction element. The method comprises: conveying a laminar blank along a first path, the laminar blank having an inner surface and an outer surface; conveying a microsuction tape along a second path, which is different from the first path; contacting a first portion of the microsuction tape with the outer surface of a first portion of the laminar blank, to secure the first portion of the microsuction tape to the first portion of the laminar blank; and cutting the microsuction tape to separate the first portion of the microsuction tape from the remainder of the microsuction tape, to thereby provide a laminar blank having a microsuction element.

The present invention therefore provides a novel method for the production of a container incorporating an improved closure means in the form of a microsuction element. Preferably, the second direction is transverse to the first direction.

Methods according to the invention are particularly suitable for the production of containers for consumer goods, where the lid is hinged to the housing and pivots relative to the housing between a closed position in which the lid covers the opening and an open position in which the opening is uncovered. This is because the pivoting movement on opening of the container can result in the microsuction layer being peeled away from the contact surface without any noticeable resistance to the user of the container. On the other hand, when the lid is pivoted into the closed position relative to the housing the microsuction layer can form a strong engagement with its contact surface and thereby provide an effective retaining means, without requiring any extra or different closing action to be undertaken by the user of the container. The methods of the present invention provide a novel way of incorporating the microsuction element on a desired position on the laminar blank without the need for significant modification of existing equipment and methods, and in particular, those used for assembly of a container from the laminar blank. In particular, the microsuction element is sourced from a microsuction tape, which is conveyed along a particular path in order to bring the microsuction element into contact with a portion of the laminar blank. At the same time, the laminar blank is also conveyed along a particular path, as is often the case with existing equipment and methods used for assembly of a container from the laminar blank. Consequently, the microsuction element can be applied to the laminar blank without significantly interfering with the conveyancing of the laminar blank, and therefore without significantly interfering with the existing manufacturing set-up.

Furthermore, cutting a microsuction tape can make it easier to apply multiple microsuction elements to multiple respective laminar blanks at high speed. The microsuction tape conveying can be synchronized with the laminar blank conveying to enable accurate registration of the microsuction element on the laminar blank.

The step of cutting the microsuction tape to separate the first portion of the microsuction tape from the remainder of the microsuction tape may be performed at the same time as, before, or after the step of contacting the first portion of the microsuction tape with the outer surface of a first portion of the laminar blank.

The laminar blank is conveyed along a first path and the microsuction tape is conveyed along a second path. In some embodiments, the first path may be substantially parallel with the second path. In such embodiments, the first path may be substantially parallel with the second path along at least two axes, with the tape being brought, or lowered, towards the laminar blank along a third axes in order to bring the two items into contact with one another.

In some embodiments, the first path may be substantially straight, and may be defined by a first conveyer belt. At least part of the second path may be substantially curved. In such embodiments, the second path may be defined by the surface of a rotating drum, which is disposed adjacent to a portion of the conveyance path of the laminar blank. In such embodiments, the microsuction tape may be carried by the rotating drum. Rotation of the drum can thereby act to bring the first portion of the microsuction tape into contact with the outer surface of a first portion of the laminar blank.

In some embodiments, the first path may be substantially transverse to the first path. For example, in such embodiments the first path may be substantially straight, and may be defined by a first conveyer belt. The second path may also be substantially straight, and may be defined by a second conveyer belt, which carries the microsuction tape in a direction substantially transverse to the direction of the first path.

The term “microsuction tape” is used herein to refer to a tape having a laminate structure comprising at least one microsuction layer. The laminate structure may optionally comprise additional layers, such as an adhesive layer. The microsuction tape is typically provided as a longitudinal reel.

The term “microsuction layer” is used herein to refer to a layer formed of a flexible material having a plurality of micro cavities on the external surface of the material. The walls of the micro cavities are deformable, such that, when the external surface of the material is pressed against a contact surface, a sealed environment of reduced pressure is formed between the walls of the cavities and the contact surface. This provides a suction force between the walls of the cavities and the contact surface.

The micro cavities may have a diameter of from 5 microns to 300 microns. The material may be formed of an expanded resin having a plurality of internal air bubbles. The layer may have a thickness of from 30 microns to 500 microns.

The term “microsuction element” is used herein to refer to a microsuction structure formed from at least a portion of the microsuction tape, and which comprises a microsuction layer. The microsuction layer has an inner surface and an outer surface, and at least a portion of the outer surface of the microsuction layer is exposed after the laminar blank having the microsuction element has been formed. This exposed surface defines an area or areas of the laminar blank, which when pressed against a contact surface, form a sealed environment of reduced pressure with the contact surface. The area or areas of the microsuction structure in which the microsuction layer is exposed are referred to herein as the “resealable area or areas”.

The resealable area or areas are particularly advantageous when the laminar blank is used to form at least a portion of a container, and in particular a container having a lid hinged relative to a housing. This is because the resealable area or areas of the microsuction element can provide an effective closure means for securing the lid in the closed position relative to the housing. Because the microsuction element relies on the use of negative pressure for providing a closing force, rather than, for example, chemical adhesion, the microsuction element is less likely to deteriorate and become less effective after several repetitions of opening and closing of the lid. Advantageously, loose material from the consumer goods, for example, loose tobacco from smoking articles, does not stick to the microsuction structure. This enables the appearance and the function of the microsuction structure to be retained during use.

Accordingly, preferably, the microsuction tape comprises a microsuction layer having an inner surface and an outer surface. Preferably, the first portion of the microsuction tape is contacted with the outer surface of a first portion of the laminar blank, such that at least a portion of the outer surface of the microsuction layer is exposed after the laminar blank having the microsuction element has been formed.

As noted above, the microsuction tape may comprise one or more additional layers in addition to the microsuction layer. In some preferred embodiments, the microsuction tape further comprises an adhesive layer underlying the microsuction layer. In such embodiments, the contacting step further comprises: contacting the adhesive layer of the first portion of the microsuction tape with the outer surface of the first portion of the laminar blank. In this way, the adhesive layer secures the microsuction element to the first portion of the laminar blank. This may be advantageous where it is desirable to secure the microsuction element to the first portion of the laminar blank, without any particular prior treatment to the laminar blank. Suitable adhesives for forming the adhesive layer include water based adhesives and solvent based adhesives. Preferably, the adhesive layer is formed from a water based adhesive.

In some preferred embodiments, the microsuction tape further comprises a polymeric film layer disposed between the inner surface of the microsuction layer and the adhesive layer. Preferably, the polymeric film layer is a layer of a polyester film, particularly preferably a layer of polyethylene terephthalate (PET).

The microsuction tape of the present invention may simply be brought into contact with the laminar blank in order to provide the microsuction element on the laminar blank. In this case, the microsuction element may be secured to the laminar blank, by means of an adhesive layer, or by means of the inner surface of the microsuction layer. However, in some preferred embodiments, the contacting step comprises: pressing the first portion of the microsuction tape onto the outer surface of the first portion of the laminar blank. Pressing may assist with obtain a secure attachment of the microsuction element to the laminar blank. The pressing force may be provided by a dedicated pressing device. Alternatively, the pressing force may be provide by the configuration of the devices conveying the laminar blank and the microsuction tape. For example, where the laminar blank is being conveyed by a first conveyer, and the microsuction tape is being conveyed by a rotating drum, the drum may be orientated relative to the first conveyer such that rotation of the drum causes the first portion of the microsuction tape to be pressed against the outer surface of the first portion of the laminar blank.

By pressing the first portion of the microsuction tape onto the outer surface of the first portion of the laminar blank, a sealed environment of reduced pressure is formed between the walls of the cavities and the outer surface of the first portion of the laminar blank. This provides a suction force between the walls of the cavities and the outer surface of the first portion of the laminar blank, and thereby helps the microsuction element to become securely attached to the laminar blank.

According to the invention, one or both of the microsuction tape and the laminar blank may be supplied to their conveyance path from a respective reel. Accordingly, preferably the step of conveying the laminar blank comprises conveying a reel of a sheet material and cutting one or more laminar blanks from the reel. Alternatively or additionally, preferably, the step of conveying the microsuction tape comprises conveying the microsuction tape from a reel of microsuction tape material.

Preferably, the microsuction tape is conveyed on a backing material. In such embodiments, the method preferably further comprises the step of separating the first portion of the microsuction tape from the backing material, before the step of contacting the first portion of the microsuction tape with the outer surface of the first portion of the laminar blank. This is particularly advantageous when the microsuction tape comprises and adhesive layer, since the backing material can prevent the adhesive layer from becoming exposed, until the point at which the first portion of the microsuction tape is contacted with the outer surface of the first portion of the laminar blank.

As noted above, methods according to the invention are particularly suitable for the production of containers for consumer goods, and more specifically, for containers where a lid is hinged to a housing and pivots relative to the housing between a closed position in which the lid covers the opening and an open position in which the opening is uncovered. This is because the microsuction element can advantageously be used to ensure that the lid remains in the closed position during normal handling, so that, for example, the consumer goods do not accidentally get exposed or fall out of the container. For example, for smoking articles it can be particularly important that the lid remains tightly shut in the closed position, so that the freshness of the articles can be preserved.

Accordingly, preferably the laminar blank is configured to be folded to form at least a portion of a container for consumer goods. Preferably, the container comprises: a housing having an opening for accessing the consumer goods; and a lid connected to the housing and movable relative to the housing between a closed position in which the lid covers the opening and an open position in which the opening is uncovered.

Preferably, at least part of the lid overlies the housing when in the closed position. In such embodiments it can be advantageous for the microsuction element to be located on an inner surface of the lid. That is, preferably, the first portion of the blank is configured to be folded to form the inner surface of a portion of the lid of the container, more preferably to form the inner surface of a front wall of the lid of the container. This is preferable because the microsuction can overlie a surface of the housing when the lid is in the closed position, and thus be used to hold the lid in the closed position. Furthermore, by being located on the inner surface of the lid, the microsuction element may be less exposed to the consumer during normal handling, and thus less likely to come into contact with the user. This can help to reduce the microsuction element being accidentally damaged.

Preferably, the side of the laminar blank that has the microsuction element corresponds to the outer surface of the container when the laminar blank is folded to form at least part of the container. In this way, the microsuction element can be provided on the same side of the laminar blank as that which is printed during manufacture.

Preferably, the housing of the container has a second portion, which is configured to engage with the first portion of the microsuction tape, when the lid is in the closed position. Preferably, the second portion is formed by an inner frame. That is, preferably, the method of the first aspect of the present invention further comprises providing an inner frame blank configured to be folded to form an inner frame forming part of the housing, wherein the second portion of the housing is defined by the inner frame.

Preferably, the method further comprising affixing the inner frame blank to the laminar blank such that the portion of the inner frame defining the second portion of the housing extends beyond the periphery of the laminar blank. In this way, the surface of the second portion to which the microsuction element engages may be spaced back from the exterior surface of the housing, such as the exterior surface of the box front wall. This can advantageously allow for a flush front wall of the container to be formed when the lid is in the closed position, because the microsuction element can engage with the outer surface of the second portion on the inner frame and help to retain the lid front wall flush with the housing front wall when the lid is in the closed position.

The inner frame blank may be affixed to the laminar blank by way of an adhesive. The inner frame blank may comprise a single panel which forms an inner frame front wall panel. The inner frame may additionally comprise first and second inner frame side wall panels, which are configured to be folded relative to the inner frame front wall panel to respectively form first and second inner frame side walls.

The housing and lid of containers according to the invention may have any suitable structure. However, in some particularly preferred embodiments, the housing comprises a box comprising: a box front wall, a box back wall, first and second box side walls, and a box bottom wall, wherein the first surface of the housing is located on the box front wall. The lid is typically connected to the box along a hinge line extending across the back wall of the container. In such embodiments, in the closed position of the lid, at least part of the lid front wall overlies the box front wall and the first surface of the lid is located on the inner surface of the lid front wall.

As used herein the terms “side”, “top”, “bottom”, “front”, “back” and other terms used to describe relative positions of the components of containers according to the invention refer to the container in an upright position with the lid at the top and the box bottom wall at the bottom. When describing containers according to the present invention, these terms are used irrespective of the orientation of the container being described.

The term “panel” is used herein to refer to a portion of the container formed from a single, continuous portion of material. A panel may depend along one or more fold lines from one or more other panels. The term “flap” refers to a panel that depends along only one fold line from only one other panel.

The term “wall” refers more generally to a facet of the container, and a wall may be formed from a single panel or flap, or a wall may be formed from two or more abutting or overlapping panels or flaps.

Containers produced by methods according to the present invention are preferably in the form of a hard-pack container which has a relatively rigid three dimensional structure.

Containers according to the present invention find application for consumer goods, in particular elongate consumer goods such as smoking articles. Preferably, the container contains a bundle of smoking articles within the housing. It will be appreciated that through appropriate choices of the dimensions thereof, containers according to the invention may be designed for different numbers of conventional size, king size, super-king size, slim or super-slim cigarettes. Alternatively, other consumer goods may be housed inside the container.

Preferably, the container is formed from one or more folded laminar blanks. The one or more folded laminar blanks may be formed from any suitable material or combination of materials, including, but not limited to, cardboard, paperboard, plastic, metal, or combinations thereof. Preferably, the blank is a laminar cardboard blank having a weight of between about 100 grams per square metre and about 350 grams per square metre. In preferred embodiments, the blank has a thickness of from about 200 to about 400 micrometres, more preferably from 250 micrometres to 350 micrometres.

The container is preferably a rectangular parallelepiped container comprising two wider walls spaced apart by two narrower walls. A hinge lid container shall typically comprise two longitudinal rounded or bevelled edges on the front wall, and/or two longitudinal rounded or bevelled edges on the back wall. These may optionally be in combination with one or more rounded or bevelled transverse edges.

The exterior surfaces of containers according to the invention may be printed, embossed, debossed or otherwise embellished with manufacturer or brand logos, trade marks, slogans and other consumer information and indicia.

In any of the embodiments described above in which the housing comprises a box, the lid may comprise a flap that is hinged to the box, the flap comprising a top flap portion that overlies the top of the box when the flap is in the closed position and a front flap portion that at least partly overlies the box front wall when the flap is in the closed position, and wherein the first surface of the lid is located on the inner surface of the front flap portion. Preferably, the box comprises a top wall at least partially defining the opening for accessing the consumer goods, in which the opening extends across the top wall from the front edge of the top wall and wherein the periphery of the opening is spaced apart from the rear edge and the side edges of the top wall so that the top wall extends around the rear and sides of the opening. Preferably, the opening also extends part way down the box front wall from the front edge of the box top wall, and when the flap is in the closed position, the front flap portion overlies the part of the opening that extends part way down the box front wall and also overlies at least a part of the overlies the box front wall.

Alternatively, in any of the embodiments described above in which the housing comprises a box, the lid may comprise a lid front wall, a lid back wall, first and second lid side walls, and a lid top wall, and wherein the first surface of the lid is located on the inner surface of the lid front wall. Preferably, the lid front wall comprises a lid front wall outer panel defining the outer surface of the lid front wall, and a lid front wall under panel defining the inner surface of the lid front wall. In such an embodiment, the lid front wall under panel depends from and underlies the lid front wall outer panel.

Preferably, the first portion of the laminar blank forms part of the lid of the container, more preferably, the first portion of the laminar blank forms part of the inner surface of the lid of the container, such as the inner surface of a front wall of the lid of the container. This can be an advantageous place to locate the microsuction element, since it can define a portion of the laminar blank, which is relatively easy to access during manufacture and therefore relatively easy to place a microsuction element on.

As noted above, methods according to the invention can allow a microsuction element to be located on a laminar blank, without significantly altering existing manufacturing machinery. Accordingly, steps of the method of the invention can be advantageously performed at particular locations in an existing manufacturing process.

For example, in some preferred embodiments, the step of contacting a first portion of the microsuction tape with the outer surface of a first portion of the laminar blank is performed at a printing station.

In some other preferred embodiments, the step of contacting a first portion of the microsuction tape with the outer surface of a first portion of the laminar blank is performed at an unloading station.

In some other preferred embodiments, the step of contacting a first portion of the microsuction tape with the outer surface of a first portion of the laminar blank is performed at a packaging station.

Preferably, the tape has a width of about 50 millimetres or less, more preferably of about 30 millimetres or less. Preferably, the tape has a width of about 5 millimetres or more, more preferably about 10 millimetres or more. The method of the invention may be extended to allow for one or more additional microsuction elements to be located on one or more additional respective laminar blanks. Accordingly, preferably the method further comprises: contacting a second portion of the microsuction tape with the outer surface of a first portion of an additional laminar blank, to secure the second portion of the microsuction tape to the first portion of the additional laminar blank; and cutting the microsuction tape to separate the second portion of the microsuction tape from the remainder of the microsuction tape, to thereby provide an additional laminar blank having a microsuction element.

According to a second aspect of the present invention, there is provided a container formed in accordance with the method of the first aspect of the present invention. It will be appreciated that any of the features described above in reference to the first aspect of the invention may also be equally applicable to the second aspect of the invention.

The invention will be further described, by way of example, with reference to the drawings in which:

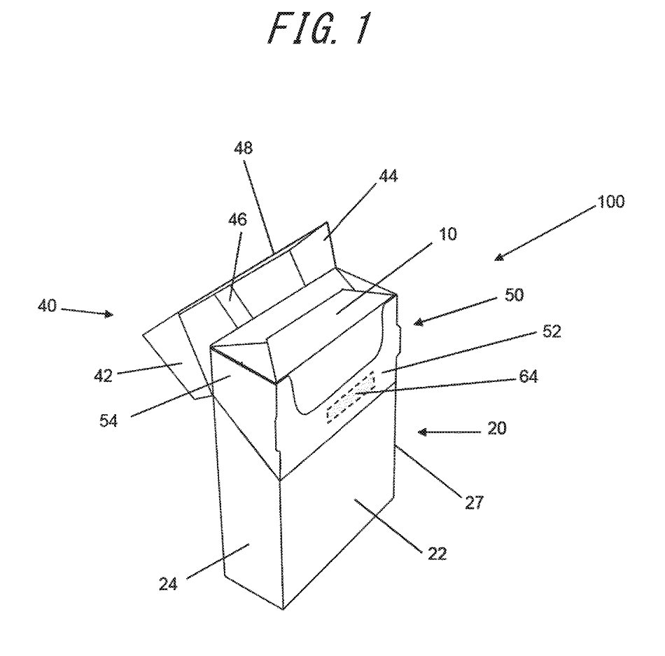

FIG. 1 is a perspective view of a container produced by a method according to the present invention, after the first opening of the lid;

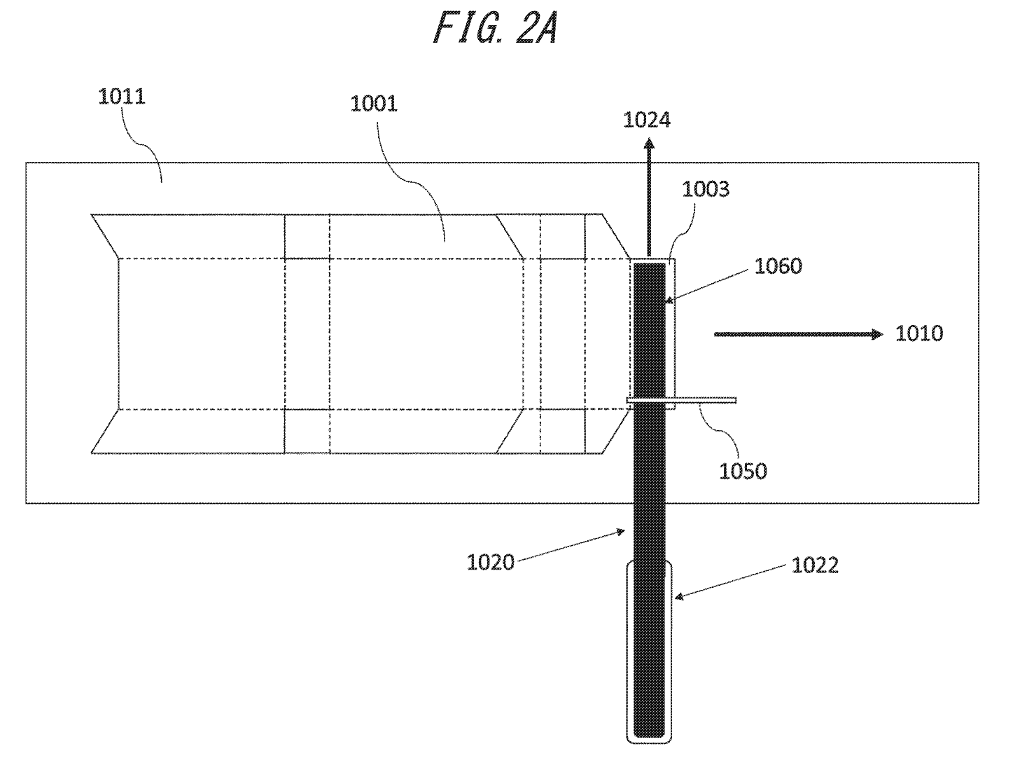

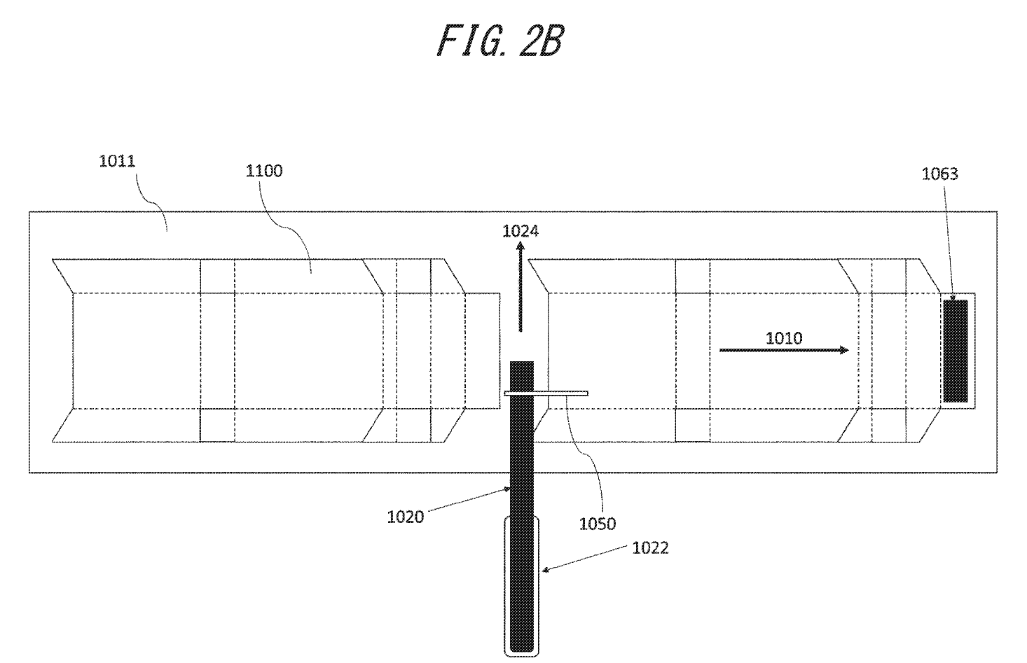

FIGS. 2A and 2B depict an overhead view of the container of FIG. 1 being produced in accordance with the method according to the present invention.

FIG. 1 shows a container 100 for consumer goods, which has been produced according to an embodiment of the present invention, where the container 100 is in an open condition. The container 100 contains a wrapped bundle of consumer goods 10, such as a bundle of cigarettes. The container has a lid 40 and a box 20 which are formed together from a single laminar blank.

The lid 40 has a first lid side wall 42, a second lid side wall 44, and a lid top wall 46. The lid 40 also has a lid front wall 48 and a lid back wall (not shown).

The box 20 has a box front wall 22, and a first box side wall 24. The box 20 also has a box bottom wall, a box back wall and a second box side wall (not shown). The lid 40 depends along a hinge line (not shown) from a top edge of the box back wall, and is movable about the hinge line between an open position (as shown in FIG. 1) and a closed position (not shown).

An inner frame 50 is attached to the inside of the box 20 and includes a first inner frame side wall 54, a second inner frame side wall (not shown), and an inner frame front wall 52. The inner frame 50 is formed from a frame laminar blank.

FIG. 1 shows the container 100 after first opening. A microsuction element 60 (not visible in FIG. 1) is provided on the inner surface of the lid front wall 48, which is configured to engage with the inner frame front wall 52 to retain the lid 40 in a closed position relative to the box 20. The dashed line in FIG. 1 indicates the second surface 64 of the inner frame front wall 52, with which the microsuction element 60 is in contact when the lid 40 is in the closed position to secure the lid in the closed position. The first surface has a corresponding shape, size and position on the inner surface of the lid front wall 48.

FIGS. 2A and 2B depict an overhead view of the container of FIG. 1 being produced in accordance with the method according to the present invention.

A container laminar blank 1001 is conveyed along a first path in a first direction 1010 by a first conveyor 1011. A microsuction tape 1020 is unwound from a reel 1022 and conveyed along a second path in a second direction 1024, which is transverse to the first direction 1010. As shown in FIG. 2A, the conveyance of the blank 1001 and the conveyance of the tape 1020 is coordinated such that a first portion 1060 of the microsuction tape 1020 overlies and comes into contact with a first portion 1003 of the laminar blank 1001, which in this case is a panel 1003 that forms the inner surface of the lid of the assembled container 100.

A blade 1050 is provided to cut the first portion of the microsuction tape 1020 to thereby form a microsuction element 1063 on the laminar blank 1001. As shown in FIG. 2B, the laminar blank 1001 and its microsuction element 1063 are then further conveyed along the second path towards an assembly station, where the laminar blank 1001 can be folded to form at least part of the container 100. A second laminar blank 1100 is then conveyed towards the tape and the blade 1050, whereby it can also be provided with a microsuction element from the microsuction tape 1020.

1. A method for producing a laminar blank having a microsuction element, the method comprising:
conveying a laminar blank along a first path, the laminar blank having an inner surface and an outer surface;
conveying a microsuction tape along a second path, which is different to the first path;
contacting a first portion of the microsuction tape with the outer surface of a first portion of the laminar blank, to secure the first portion of the microsuction tape to the first portion of the laminar blank; and
cutting the microsuction tape to separate the first portion of the microsuction tape from the remainder of the microsuction tape, to thereby provide a laminar blank having a microsuction element, wherein laminar blank is configured to be folded to form at least a portion of a container for consumer goods, the container comprising:
a housing having an opening for accessing the consumer goods; and
a lid connected to the housing and movable relative to the housing between a closed position in which the lid covers the opening and an open position in which the opening is uncovered.

2. A method according to claim 1, wherein the first portion of the blank is configured to be folded to form the inner surface of a portion of the lid of the container.

3. A method according to claim 2, wherein the first portion of the blank is configured to be folded to form the inner surface of a front wall of the lid of the container.

4. A method according to claim 1, wherein the housing of the container has a second portion, which is configured to engage with the first portion of the microsuction tape, when the lid is in the closed position.

5. A method according to claim 4, further comprising:
providing an inner frame blank configured to be folded to form an inner frame forming part of the housing, the second portion of the housing being defined by the inner frame.

6. A method according to claim 5, further comprising affixing the inner frame blank to the laminar blank such that the portion of the inner frame defining the second portion of the housing extends beyond the periphery of the laminar blank.

7. A method according to claim 1, wherein the microsuction tape comprises a microsuction layer having an inner surface and an outer surface, and wherein the first portion of the microsuction tape is contacted with the outer surface of a first portion of the laminar blank, such that at least a portion of the outer surface of the microsuction layer is exposed after the laminar blank having the microsuction element has been formed.

8. A method according to claim 7, wherein the microsuction tape further comprises an adhesive layer underlying the microsuction layer, and wherein the contacting step further comprises:
contacting the adhesive layer of the first portion of the microsuction tape with the outer surface of the first portion of the laminar blank.

9. A method according to claim 8, wherein the microsuction tape further comprises a polymeric film layer disposed between the inner surface of the microsuction layer and the adhesive layer.

10. A method according to claim 1, wherein the contacting step further comprises:
pressing the first portion of the microsuction tape onto the outer surface of the first portion of the laminar blank.

11. A method according to claim 1, wherein the step of conveying the laminar blank comprises conveying a reel of a sheet material and cutting one or more laminar blanks from the reel.

12. A method according to claim 1, wherein the step of conveying the microsuction tape comprises conveying the microsuction tape from a reel of microsuction tape material.

13. A method according to claim 1, wherein the microsuction tape is conveyed on a backing material, and the method further comprises the step of separating the first portion of the microsuction tape from the backing material, before the step of contacting the first portion of the microsuction tape with the outer surface of the first portion of the laminar blank.

14. A method according to claim 1, further comprising:
contacting a second portion of the microsuction tape with the outer surface of a first portion of an additional laminar blank, to secure the second portion of the microsuction tape to the first portion of the additional laminar blank; and
cutting the microsuction tape to separate the second portion of the microsuction tape from the remainder of the microsuction tape, to thereby provide an additional laminar blank having a microsuction element.

15. A container formed using the method of claim 1.
